(19) United States
(12) Patent Application Publication
(10) Pub. No.: US 2013/0144647 A1
(43) Pub. Date: Jun. 6, 2013

(54) METHOD AND SYSTEM FOR DENTAL ENTERPRISE RESOURCE PLANNING

(71) Applicant: Mitch Ellingson, Buckeye, AZ (US)

(72) Inventor: Mitch Ellingson, Buckeye, AZ (US)

(21) Appl. No.: 13/706,329

(22) Filed: Dec. 5, 2012

Related U.S. Application Data
(60) Provisional application No. 61/567,054, filed on Dec. 5, 2011.

(51) Int. Cl. G06Q 50/22

(52) U.S. Cl. CPC G06Q 50/22
USPC 705/2

(57) ABSTRACT

Dental enterprise resource planning systems and method are provided. The systems and methods include a user interface, a data integration engine and interface, a third party application pool, and an application module pool. Data and functionality of the various applications are integrated and delivered through a single platform.

### PRIORITY CLAIM

The present invention claims priority to and the benefit of U.S. Provisional Application No. 61/567,054 filed on Dec. 5, 2011, the contents of which are incorporated herein by reference.

### BACKGROUND OF THE INVENTION

1. Field of the Invention

The present invention is generally related to enterprise resource management for dental offices. More particularly, the present invention pertains to systems and methods for delivering dental and other office based toolsets through a single computing platform.

2. Introduction

Dentistry is becoming an increasingly technological profession. There are also more laws governing the protection of patient information (e.g., HIPAA). These laws require more sophisticated equipment and more secure physical storage areas. Dental offices are pressured to shrink costs and increase profitability in the midst of increasing IT costs caused by advances in technology.

One of largest challenges facing today's dental professionals, and dental offices in general, is maintaining the software and hardware needed to operate a dental office. Common practice is to contain all servers, systems, data, and telecommunications within the office environment on locally owned or leased computer hardware. Various dental specific software packages and application are sold to track, maintain, and operate various functions of a dental practice. Often, offices hire specialized staff to maintain and upgrade its equipment periodically and when upgraded software requires such upgrades. Such non-dental specialized hiring increases the overall cost of running a dental practice. Typically, as a dental practice grows, so do the number of office locations that require more hardware and equipment. Quickly, it becomes difficult to scale the respective infrastructure in a cost effective method.

Another challenge to operating an effective dental practice is integrating the amount of information generated by the different number of software applications used. Dental practices must schedule and track clients, file insurance claims, maintain medical records, including client images (e.g., x-rays), order supplies, process client payments, keep financial records, backup and store data. Usually two or more application systems are used to accomplish all these necessary functions and such application are becoming more complex. Such complexity requires more training and/or additional staff to simply operate the applications. Even more challenging is retrieving data from each system and integrating this data so that comprehensive picture the practice may be obtained.

What is needed is a system and method that unifies the disparate systems and tools used by a dental office into a single solution. Furthermore, what is needed is a solution that integrates the data provided by such systems into a comprehensive view of the practice.

### SUMMARY OF THE INVENTION

While the way in which the present invention addresses the disadvantages of the prior art will be discussed in greater detail below, in general, the present invention is for systems and methods for unifying commonly used dental and other dental office based toolsets into a single platform. The systems and methods provide for a dental enterprise resource planning solution.

A dental enterprise resource planning system includes a user interface system, a data integration engine and interface, a third party application pool, a platform module pool, and optional reporting engine, and a network connecting the various components of the system.

A method for configuring a dental enterprise resource planning platform includes providing a user interface, selecting third party applications to include in the platform, providing a pool of application modules, selecting one or more of the application modules to include in the platform, integrating the user interface, the selected third party application, and the selected application modules through an integration engine and interface.

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention.

### BRIEF DESCRIPTION OF THE DRAWINGS

In order to describe the manner in which the above recited and other advantages and features of the invention can be obtained, a more particular description of the invention briefly described above will be rendered by references to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary dental enterprise resource planning system.

FIG. 2 illustrates an exemplary method for configuring a dental resource planning platform.

### DETAILED DESCRIPTION OF THE INVENTION

Various embodiments of the invention are described in detail below. While specific implementations are described, it should be understood that the description here is merely illustrative and not intended to limit the scope of the various aspects of the invention. A person skilled in the relevant art will recognize that other components and configurations may be easily used or substituted than those that are described here without parting from the spirit and scope of the invention.

The present invention unifies commonly used dental and other toolsets into single platform. In an exemplary embodiment, the platform infrastructure is cloud-based. In general, the invention provides for a dental enterprise resource planning solution. In particular, the invention provides a system and method for a user interface system, a data integration engine and interface, a third party application pool, a platform module pool, and a network. The system is configurable by the user such that a user enters the system through the user interface, e.g., a web browser, selects a third party practice management solution, and selects desired application modules that provide varying functionality. The platform is configured to integrate the data and functionality the third party management selection and the application module selections into a unified platform so that the user interacts with the total functionality through a single interface. Thus, as will become apparent from the following descriptions, the system and methods of the invention facilitate delivering functionality and data relevant to a dental practice through a single platform.

For the sake of brevity, conventional data networking, application development and other functional aspects of the systems (and components of the individual operating components of the systems) may not be described in detail. The connecting lines shown in the various figures are intended to represent exemplary functional relationships and/or physical couplings between various elements. It should be noted that many alternative or additional functional relationships or physical connections may be present in a practical system.

The invention may be described in terms of functional block components, optional selections and various processing steps. It should be appreciated that such functional blocks may be realized by any number of hardware and/or software components configured to perform the specified functions. For example, the invention may employ various integrated circuit components, e.g., memory elements, processing elements, logic elements, audio and/or visual elements, input/output elements, wired or wireless communication techniques, and the like, which may carry out a variety of functions under the control of one or more microprocessors or other control devices.

Similarly, the software elements of the invention may be implemented with any programming, scripting language or web service protocols such as C, C++, C#, Java, COBOL, assembler, and the like. As those skilled in the art will appreciate, the software and hardware elements may be implemented with an operating system such as Microsoft Windows®, UNIX, Apple OS X, MacOS, Linux, and the like.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium have computer-readable program code means embodied in the storage medium. Any suitable computer-readable storage medium may be utilized, including hard disks, CD-ROM, optical storage devices, magnetic storage devices, and/or the like.

The computer program instructions may be loaded onto a general purpose computer, special purpose computer, or other programmable data processing apparatus to produce a machine, such that the instructions execute on the computer or other programmable data processing apparatus create means for implementing the functions specified in the flowchart block or blocks. The computer program instructions may also be loaded onto a computer or other programmable data processing apparatus to cause a series of operational steps to be performed on the computer or other programmable apparatus to produce a computer-implemented process such that instructions which execute on the computer or other programmable apparatus provide steps for implementing the functions specified in the flowchart block or blocks.

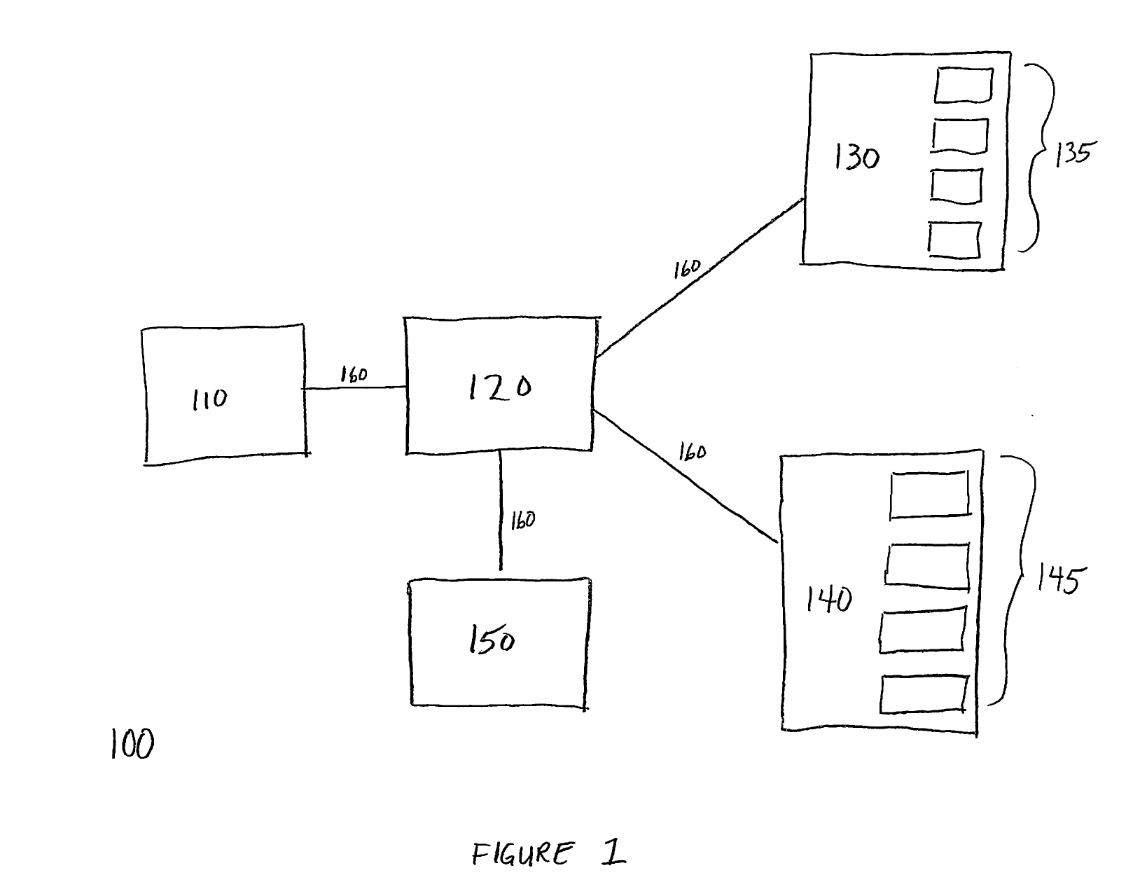

FIG. 1 illustrates, in block format, an exemplary dental enterprise resource planning (“Dental ERP”) system 100 of the invention. In its various embodiments, a Dental ERP system comprises a user interface system 110, a data integration engine and interface 120, a third party application pool 130, a platform module pool 140, an optional reporting engine 150, and a network 160 connecting the various components. Depending on the physical configuration, these systems may use a variety of methods to communicate with each other. For example, in some embodiments, the systems may communicate over one or more networks 160 using protocols suited to the particular system and communication. As used herein, the term “network” shall include any electronic communications means which incorporates both hardware and software components. Communication among the systems may be accomplished through any suitable communication channels, such as, for example, a telephone network, an extranet, an intranet, Internet, portable computer device, personal digital assistant, online communications, satellite communications, off-line communications, wireless communications, transponder communications, local area network, wide area network, networked or linked devices, keyboard, mouse and/or any suitable communication or data input modality. In some embodiments, these systems are contained within a single physical unit and appropriately coupled through various integrated circuit components. In other embodiments, one or more of the systems are implemented within a cloud framework. Various cloud platform systems that enable the ability to develop, store, and execute application functionality are well known and will not be described here.

User interface 110 includes any hardware and/or software suitably configured to enable users access to the Dental ERP system 100. In various embodiments, a user may be a dental professional or dental office/administrative staff, clients (i.e., customers), personnel from third-party software providers that provide functionality to the system, Dental ERP personnel, and/or another computer system or application. In one embodiment, the user interface is the only interface dental practice personnel need to access the full functionally of the Dental ERP 100 system. In an exemplary embodiment, the user interface 100 comprises a single sign-on system configured to provide access to any application or system within the Dental ERP system 100. One or more of the components of the Dental ERP may require a security authorization separate from the Dental ERP system to access certain functionality. The single sign-on system provides such authorization without querying the user for additional authorization information. In an exemplary embodiment, the user accesses the Dental ERP through a username and password. Single sign-on systems are well known in the art and will not be described in further detail.

User interface 110 also includes any hardware and/or software suitable configured to present the functionality of the Dental ERP system 100 and retrieve data input from users. In general, the user interface receives data from, and provides data to, the data integration engine and interface 120 and renders such data as is appropriate for the particular system employed by the user. In one embodiment, the user interface 110 may render the data received exactly as received (i.e., “pass-thru”) from the data and integration engine and interface. This method may be used when a third party application's graphical user interface must be presented to a user rather than the Dental ERP's graphical user interface. In another embodiment, the user interface 110 receives only data and the user interface 110 renders a graphical user interface for the user of the system. In an exemplary embodiment, the user interface 110 renders the user interface using both methods.

A user may use various applications or systems to access the user Dental ERP system 100. In an exemplary embodiment, access to the system is achieved through a web browser. In other embodiments, access is achieved wholly or partially through a plug-in or similar application software resident on a user's system. In yet another embodiment, users may gain access using well-known remote access desktop application software.

A data integration engine and interface 120 includes any hardware and/or software suitably configured to capture/receive, store, and enable retrieval of relevant data from the third party application pool 130 and platform module pool 140 and to provide/receive such data to/from the user interface 110. The data and integration engine and interface 120 may utilize one or more databases or file structures suitable to record and manipulate data within the time frames required by the invention. Database may be any type of database, such as relational, hierarchical, object-oriented, or similar data management structures. Database systems are well known and will not be described in detail. However, the data storage may be organized in any suitable manner, including flat files, data tables, lookup tables, or the like. Association of certain data may be accomplished through any data associated technique known and practiced in the art. One skilled in the art will also appreciate that any databases, systems, devices or other components of the system may consist of any combination at a single location or at multiple locations. In its embodiments, the data integration engine and interface 120 securely stores and manipulates its data according to required regulatory requirements (e.g., HIPAA).

The data integration engine and interface 120 may store some or all of the data required for the Dental ERP system's needs. In one embodiment, the data integration engine and interface 120 acts as a pass-thru to third party applications within the third party application pool 130. In another embodiment, the data integration engine and interface 120 stores all data passing through the interface. In this embodiment, the interface may employ a data synchronization scheme to keep third party data and the Dental ERP system data current. The interface may utilize various methods to connect with third party application within the application pool 130. In other embodiments, the data integration engine and interface 120 may interface with third party applications resident on a user's desktop or in a location remote to the Dental ERP system (not shown in FIG. 1). The data integration engine and interface 120 connects with the third party application and obtains data from the application. This data is then stored within the Dental ERP system and may be used and/or analyzed as if the third party application was within the third party application pool 130. In another embodiment, the data integration engine and interface may send data to the third party application for use by the application.

An optional feature of the data integration engine and interface 120 is the ability to migrate data from a user's system of record to another. Such migration capability supports the ability to easily upgrade or change third party applications within the third party application pool. In an exemplary embodiment, a user may desire to switch their third party dental practice management solution. A user may select their desired practice management solution through the Dental ERP system without the to first download data to a compatible file and later import such data into the new application. The migration of data is automatic between the applications such that the migration of data appears to be seamless to the user.

A third party application pool 130 includes any hardware and/or software suitably configured to integrate third party software or systems 135 within the Dental ERP system as may be needed for a particular user. In general, the third party application pool contains third party applications commonly used for dental practice management or other functions. The third party application pool 130 may include application add-ons, modules, or updates to the various third party applications. In its embodiments, a user select the desired third party application presented by the Dental ERP through the user interface. Such selection informs the system that the particular user desires to have the functionality and data of the third party application integrated into their overall Dental ERP implementation. In an exemplary embodiment, the selection of third party software is plug and play such that the user simply selects the particular software and may begin using the software within their particular Dental ERP implementation as soon as possible.

In some embodiments, the third party application pool 130 delivers and installs the third party application onto the systems of the user. In one embodiment, the third party application pool 130 is suitably configured to activate and implement the licensing/usage models for the various third party applications. Such activation may include activation, information collecting and passing, charge models, payment collection, and revenue distribution based on the installation of the third party application. In other embodiments, the third party application pool 130 may contain only the add-ons, modules, or updates for particular third party applications to install on a user's system in the same manner.

A platform module pool 140 includes any hardware and/or software suitably configured to integrate functionality within a particular user's Dental ERP implementation. In general, the Dental ERP system 100 provides application functionality to effectively operate and manage a dental practice(s). In various embodiments, the platform module pool 140 contains modules 145 of functionality that may be selected and enabled by a user to be included within their particular implementation. In an exemplary embodiment, the modules 145 are available to be selected on a plug and play basis. For example, upon sign up, a user may select two modules to be included in their implementation. At a later time, the user may decide to deselect one of the modules and select two more based on the needs of the dental practice at that time. The platform module pool 140 installs or makes available/unavailable the particular functionality upon the user's selections. The other components of the Dental ERP system 100, for example, the data integration engine and interface 120, are notified by the platform module pool 140 of a particular user's selection and manage the user's data accordingly. In some embodiments, some modules are mandatory for each Dental ERP system implementation.

Modules 145 of functionality are varied and suitably configured such that if a particular module is included within a particular Dental ERP implementation, its operation is seamless with other modules and components of the system. A module 145 may comprise any type of functionality suitable to dental practice enterprise resource planning and management. Module functionality may overlap or supersede application functionality provided by third party application providers available within the third party application pool 130. The following module descriptions are examples of the type of functionality that may be integrated into a Dental ERP implementation and are not intended to limit the types of functionality that may be implemented with the Dental ERP system 100.

In various embodiments, an Insurance Module includes any hardware and/or software suitably configured to provide functionality to secure information provided by e-filing systems of the third-party practice management systems (e.g., Dentrix™, Eaglesoft™, QSi™, Carestream™, Curve™). In an exemplary embodiment, insurance related information is passed from the third-party practice management system to the Insurance Module. The information is utilized to gain pre-authorizations, explanations of benefits, claim denial disputes, or other actions or information typical to the dental insurance industry.

Once the insurance action requested has been satisfied the information is provided to the third-party system. The module then prompts the user, by patient name, that the issue has been resolved. The information is stored in a patient's information record.

Current standard office practice to process claims includes complex interactions with third-party (sometimes offshore) groups and insurance carriers. The need to have these third parties interact with the internal staff of the dental office is a security risk, is known to be inefficient and requires local dental professional/management assistance during the process. In an optional exemplary embodiment, the system will allow a secure but separate area, for example, a private cloud environment, for offsite third parties to access needed claims information. Claims may be processed and updated directly to the private cloud environment.

In various embodiments, the Patient Services Module includes any hardware/software suitably configured to provide functionality for a virtual patient concierge portal. The module enables a client or patient to view/manage either future or past appointments. The module may also send or otherwise initiate communication regarding reminders to the patient. In exemplary embodiments, the reminders that can be utilized are appointment, payment, doctor's directions (i.e. please take pre-medication), and other general patient information. Other services that may be provided are surveys and after hours scheduling or appointment requests. The patient can also request prescription refills and any adjuncts to upcoming appointments.

In various embodiments, the Centralized Patient Database Module includes any hardware and/or software suitably configured to obtain data from patient charting systems and normalizes this data in a centralized database for each patient. The database will track of what types of treatment the patient has had (both medical and dental), the types of materials used during procedures, and the clinical outcome of all patient visits. In some embodiments, this data enables access to the patient's history of treatments and materials to more accurately help the patient. It will also increase the safety to the patient and efficiency of the office.

The database tracks of patient information and makes such information accessible to other modules, such as the Patient Services Module. In some embodiments, this module is connected to a Dentist Portal, an Office Portal, and a Patient Portal. The Patient Portal enables real-time treatment planning such that patients can be educated on their condition and the reasoning behind the treatment. In one embodiment, once treatment is completed data will be presented in a graphical nature that will help the patient to understand the nature of the treatment and the outcome post treatment.

The module may also obtain data from a patient portal or similar system that stores patient health-related data. In this embodiment, dental patient data is obtained and may be de-identified and stored in a dental health information exchange. The dental health information exchange contains any data pertinent to any dental service rendered to a patient. Analysis or retrieval may be performed on the data contain within the dental health information exchange. In other embodiments, a dental health information exchange and a generic health information exchange may communication with each other to obtain a full health profile of patients.

In various embodiments, the Inventory Module includes any hardware and/or software suitably configured to manage dental practice inventory through predictive modeling and is calibrated using scanning techniques, such as bar code scanning inventory items or connecting with RFID tags. Predictive modeling is a well-known technique in the art and will not be further described here. In an exemplary embodiment, the module accepts scans of dental instrument blocks (i.e., bur blocks) that have been designed to better track the small pieces of inventory expended in a dental office. In another embodiment, cartridge dispensers may be scanned that track inventory automatically. This module communicates with purchasing systems that a particular office uses and helps automate a purchase event as supply levels reach practice pre-defined thresholds.

In various embodiments, the Merchant Services Module includes any hardware and/or software suitably configured to incorporate a merchant services gateway into the Dental ERP system. The module provides typical merchant services processes and reporting. In an exemplary embodiment, the module provides secure automated payment processing for office transactions occurring through the Dental ERP system. In various embodiments, the module includes ultra-secure charge models, HIPAA compliant interaction with client information, and secure virtual terminal, gateway and bank payment flows. In other embodiments, the module is office configurable and permits the elimination of common swipe machines. In its embodiments, merchant services data integrates with the Business Intelligence Module to enable to date reporting.

In its various embodiments, the Business Intelligence Module includes any hardware and/or software suitably configured to provide functionality to receive data from other components of the system 100, aggregate, normalize and parse such data, and present the data to users through the user interface. The module collects data over time so that predictive measures may be based on trends in the data. The module's data may be displayed in various time period, such as years, month, days, hours, etc. The module's data may also be displayed via geography (e.g., local, regional, national). However, any suitable field or filter may be applied to gain an analysis useful to users of the system. In exemplary embodiments, the module is used to provide information in the following areas of dental practice:
1. Practice Operations Goal Setting and Measurement
2. Practice Overhead and Profit Management
3. Scheduling Operations
4. Financial Arrangements & Collections
5. Production Operations
6. New Patient Acquisition
7. Custom Exam Design
8. Treatment Planning
9. Internal & External Marketing
10. Hygiene Recall Management

In various embodiments, additional modules complement the functionality of the Dental ERP system 100. Each additional module may be implemented separately from the others. One available module includes an Integration Evaluation service that track the usage of other modules to ensure a particular user or office is using the modules effectively.

Another available module includes an Issue Tracking Service. This module tracks break/fix status and proactively identifies problematic functions within other modules or applications.

Another available module includes an Adjunct Application Delivery Service. This module enables the delivery of various applications relevant to dentistry, such as financial planning or continuing education.

Other modules may utilize dental procedure codes to activate other functionality within the system. For example, third party practice management software developers may use procedure codes to integrate additional modules within the Dental ERP system or additional functionality within their own software.

Another available module includes a Target Advertising Service. This module examines practice procedures utilization trends to display relevant and beneficial advertising mediums. In an exemplary embodiment, the module, coupled with third party practice management systems, obtains treatment codes and other data related to an office's daily procedures and treatments. Based on this data, the module may push advertising pertinent to the procedures and/or treatments and overall business trends.

Another available module is a Continuing Education Service. The module will provide customizable clinical tutorial sessions. In an exemplary embodiment, the module obtains procedure codes from a third party practice management system and provides clinical sessions based on the codes. Identified treatments trends also may be analyzed to suggest the appropriate clinical training session.

Another available module is an Imaging Service. The module permits the viewing, moving, storage and archival of images commonly utilized within a dental facility.

Another available module is a Data Protection Service. This module will natively provide restore-ready data from advanced data backup and protection strategies (i.e. geo-diverse redundant storage systems, database & server snapshots, long-term archival systems) and secured from any view other than qualified personal from the dental facility. The data protection and recovery strategies would be designed to exceed local, state, or other (HIPAA) regulatory guidelines and requirements.

A reporting engine 150 includes any hardware and/or software suitably configured obtain needed data from the Dental ERP system 100 and enable reporting based on overall system and individual practice needs. In an exemplary embodiment, reporting engine provides generic, custom and specialized reporting on any fields available within the Dental ERP system.

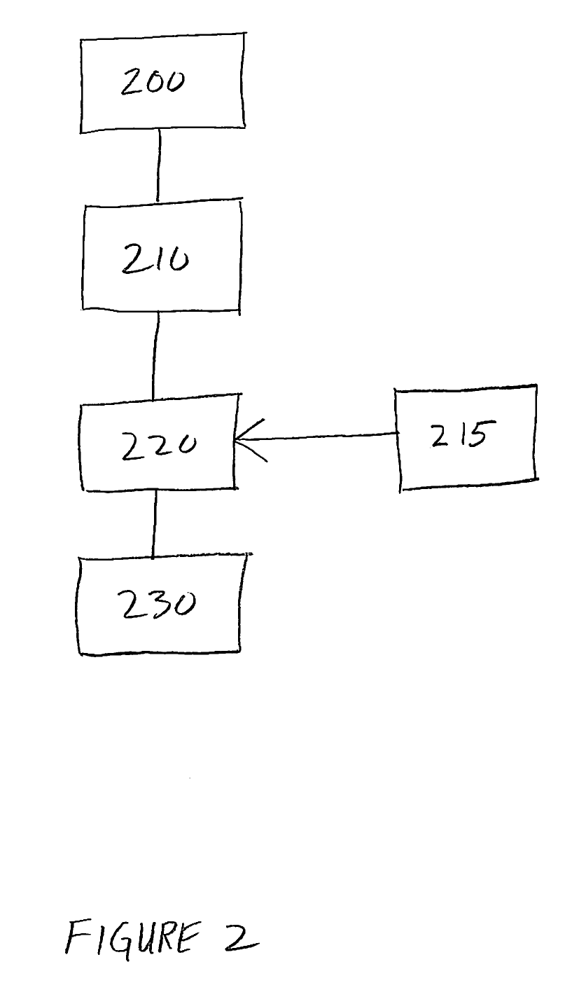

FIG. 2 illustrates, in block format, a method for configuring a dental enterprise resource planning platform. The method comprises the steps of providing a user interface 200, selecting third party applications to include in the platform 210, providing a pool of application modules 215, selecting one or more of the application modules to include in the platform 220, integrating the user interface, the selected third party application, and the selected application modules through an integration engine and interface 230.

Although the above description may contain specific details, they should not be construed as limiting the claims in any way. Other configurations of the described embodiments of the invention are part of the scope of this invention. The descriptions and embodiments are not intended to be an exhaustive or to limit the invention to the precise forms disclosed. Accordingly, the appended claims and their legal equivalents should only define the invention, rather than any specific examples given.

What is claimed is:

1. A dental enterprise resource planning system comprising:
a user interface system;
a data integration engine and interface;
a third party application pool;
a platform module pool; and
a network connecting the user interface system, the data integration engine and interface, the third party application pool, and the platform module pool.

2. A method for configuring a dental enterprise resource planning platform comprising the steps of:
providing a user interface;
selecting third party applications to include in the platform;
providing a pool of application modules;
selecting one or more of the application modules to include in the platform; and
integrating the user interface, the selected third party application, and the selected application modules through an integration engine and interface.
